(19) United States
(12) Patent Application Publication
(10) Pub. No.: US 2007/0232134 A1
(43) Pub. Date: Oct. 4, 2007

(54) PROTECTIVE COVER FOR RACK MOUNTED NETWORKING EQUIPMENT

(76) Inventors: Alain Desrochers, Laval (CA); Yannick Demers, Montreal (CA)

Correspondence Address: GOUDREAU GAGE DUBUC, 2000 MCGILL COLLEGE, SUITE 2200, MONTREAL, QC, H3A 3H3, US

(21) Appl. No.: 11/694,509

(22) Filed: Mar. 30, 2007

Related U.S. Application Data
(60) Provisional application No. 60/787,640, filed on Mar. 31, 2006.

(51) Int. Cl. H01R 13/73

(52) U.S. Cl. 439/557

(57) ABSTRACT

A protective cover for securing networking equipment installed on a rack, the networking equipment comprising a front face including at least one cable plug receiving socket and at least one cable terminated by one of the sockets is provided. The cover comprises an elongate covering portion dimensioned to conceal the front face and defining a cable receiving region, the covering portion comprising at least one side opening at an end thereof and a means for mounting the covering portion to the front face. At least one cable exits the cable receiving region via the side opening.

### CROSS REFERENCE TO RELATED APPLICATIONS

This application claims priority on U.S. provisional application No. 60/787,640, filed on Mar. 31, 2006 which is incorporated herein in its entirety by reference.

### FIELD OF THE INVENTION

The present invention relates to a protective cover for rack mounted networking equipments. In particular the present invention relates to a cover for fastening over a series of cable plug/receptacle socket interconnections on a network rack in a patch bay or the like, for example in order to protect the interconnections by preventing unauthorised removal of the connector plugs from the receptacles.

### BACKGROUND

In a networking environment, racks are used to suspend active equipment (such as switches, servers, and the like), cross connecting equipment (such as patch panels, mini racks, cable management, and the like) and other required equipment. Such racks may be installed in main telecom rooms, telecom closets and in data center environments. One drawback is that these environments are typically of limited space and therefore only a limited number of such racks can be provided. As a result the in-rack space is also limited. As data networking continues to grow, increasing numbers of connections are required generally, however, without any increase in the space allocated for those connections. As a result there is a corresponding trend towards higher density and better utilisation of rack space.

Another drawback of the prior art is that current installations typically use cable management equipment that consumes prime in-rack space that could be used for cross connecting patch panels, which further increases the overall density of connections per rack.

Still another drawback of the prior art is that the interconnection between patch cord and networking equipment remains unprotected and an easy target for inadvertent or advertent (for example, malicious unplugging of the patch cords from the networking equipment) disconnection of the patch cord from the networking equipment.

### SUMMARY OF THE INVENTION

In order to overcome the above and other drawbacks there is provided a protective cover for securing networking equipment installed on a rack, the networking equipment comprising a front face including at least one cable plug receiving socket and at least one cable terminated by one of the sockets. The cover comprises an elongate covering portion dimensioned to conceal the front face and defining a cable receiving region, the covering portion comprising at least one side opening at an end thereof and a means for mounting the covering portion to the front face. At least one cable exits the cable receiving region via the side opening.

### BRIEF DESCRIPTION OF THE FIGURES

FIG. 1 is a raised right front view of a protective cover mounted on a rack mounted networking equipment in accordance with an illustrative embodiment of the present invention;

FIG. 2 is a detailed raised left front view of a protective cover mounted on a rack mounted networking equipment in accordance with an illustrative embodiment of the present invention;

FIG. 3 is a side plan view of a protective cover for rack mounted networking equipment in accordance with an illustrative embodiment of the present invention;

FIG. 4 is a side plan view of a protective cover mounted on a rack mounted networking equipment in accordance with an illustrative embodiment of the present invention;

FIG. 5 is a raised right front view of a plurality of protective covers mounted on a rack mounted networking equipment in accordance with an illustrative embodiment of the present invention;

FIG. 6 is an exploded raised left front view of a protective cover mounted on a rack mounted networking equipment in accordance with an alternative illustrative embodiment of the present invention; and

FIG. 7 is a raised left front view of a protective cover mounted on a rack mounted networking equipment in accordance with an alternative illustrative embodiment of the present invention.

### DETAILED DESCRIPTION OF THE ILLUSTRATIVE EMBODIMENTS

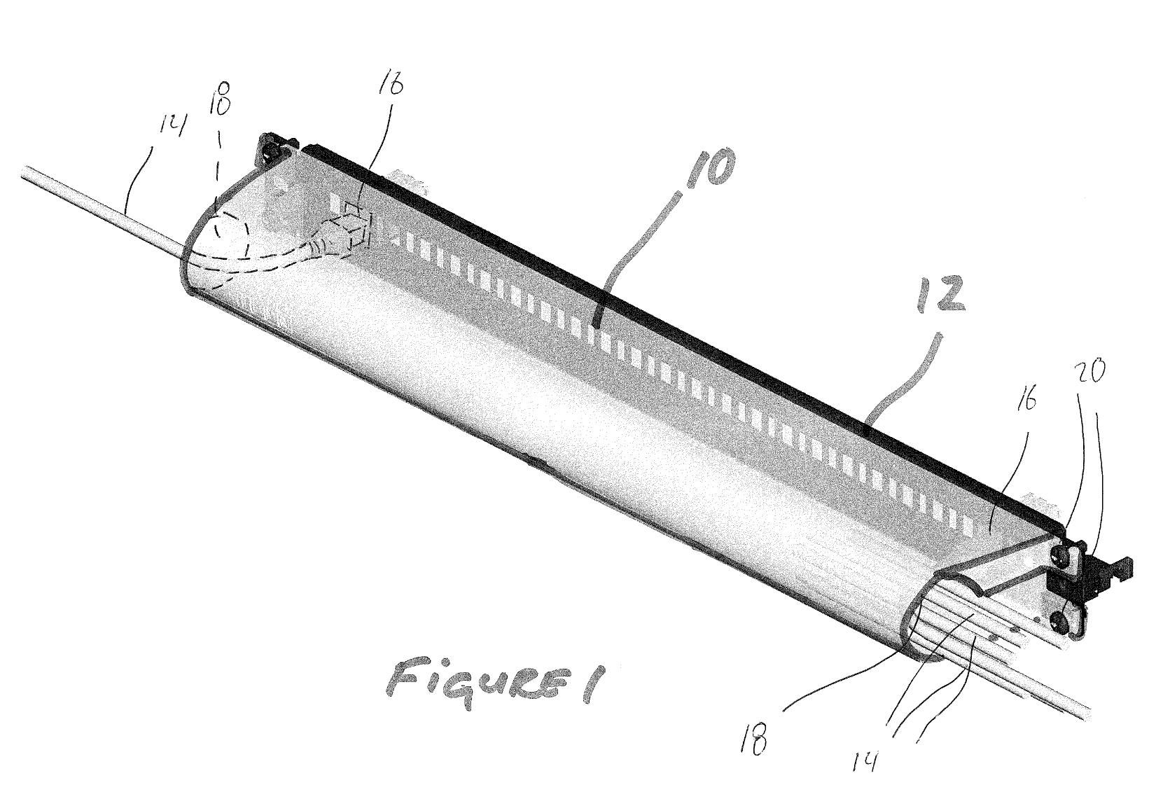

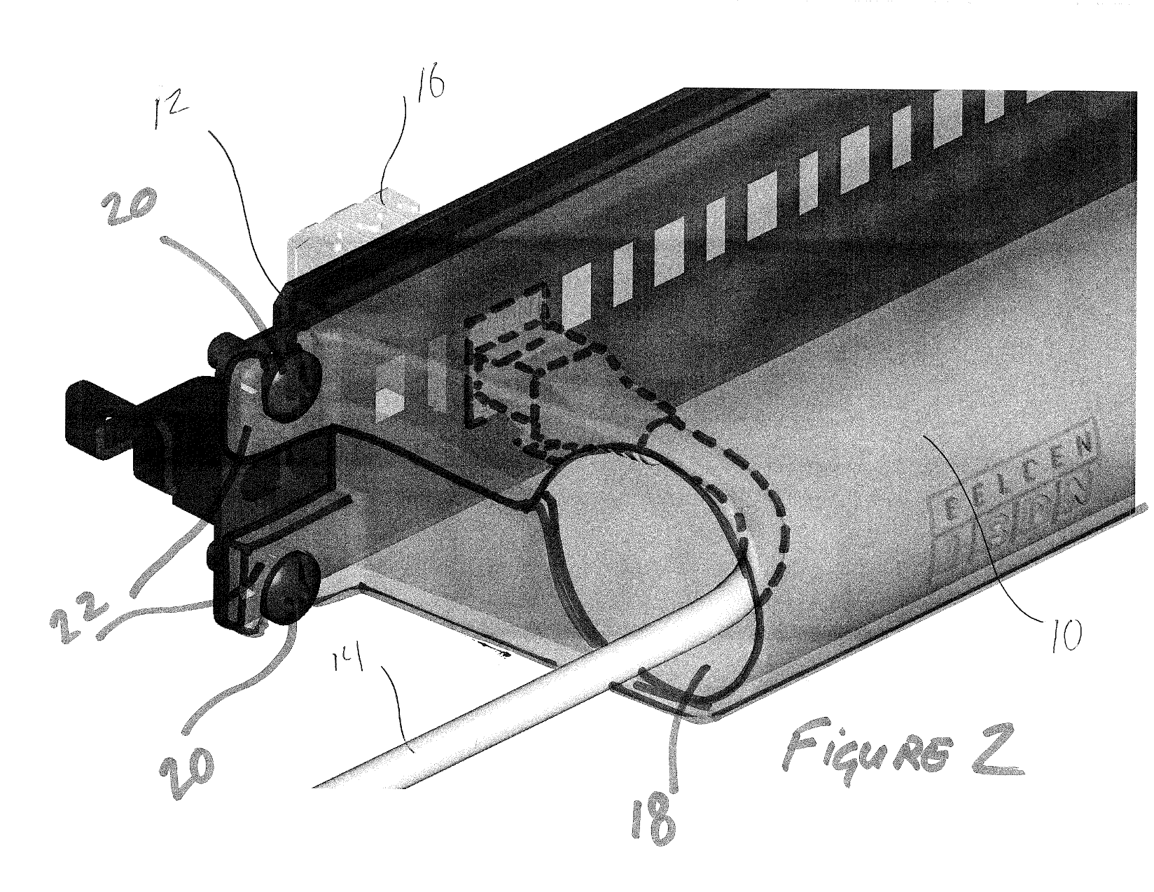

Referring now to FIGS. 1 and 2, a protective cover for rack mounted networking equipment, generally referred to using the reference numeral 10, will be described. The cover 10 provides a security enclosure suitable for retrofit to an existing rack mounted active or passive networking equipment 12, including but not limited to patch bay panels and the like. The cover 10 provides additional protection and support for patch cords as in 14 interconnected with sockets as in 16 arranged along the front of the networking equipment 12 and redirection of the patch cords or cables as in 14 towards side cable guides (not shown) typically used within the same rack space of the networking equipment 12.

The protective cover 10 provides a secured cable management solution that uses the same rack space as the networking equipment 12 to which the cable management solution is mounted. The protective cover 10 acts, for example, as an anti-vandalism cover securing the connection ports of the networking equipment 12 and also provides a means for arranging the patch cords or cables as in 14 attached to the networking equipment 12 such that they exit a side opening 18. The protect cover 10 can be attached to the networking equipment 12 either on the front, as shown, or alternatively on the back of the networking equipment 12. The protective cover 10 is illustratively retrofit mountable to the existing networking equipment 12 via the four bolts as in 20 which secure the networking equipment 12 to the equipment rack (not shown) and four mounting tabs as in 22 having “U” shaped openings which are moulded or otherwise formed in the protective cover 10.

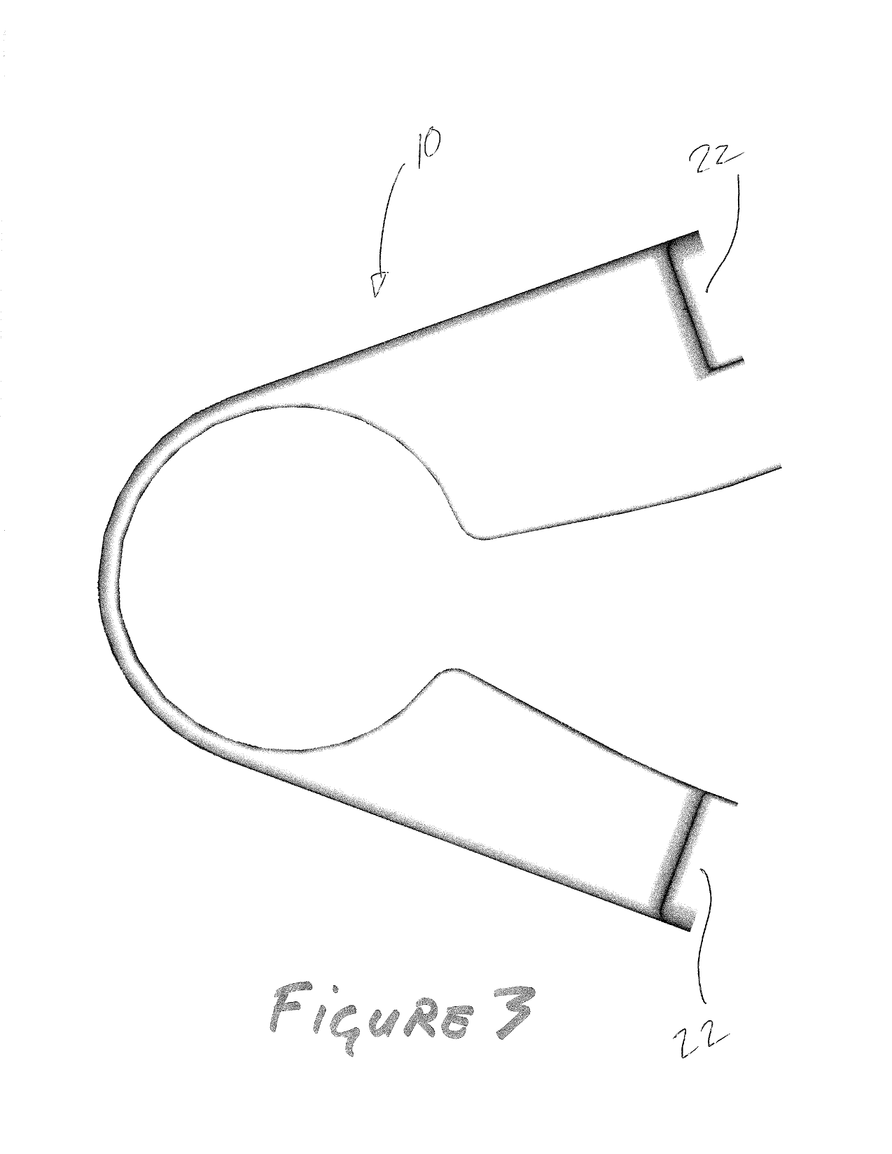

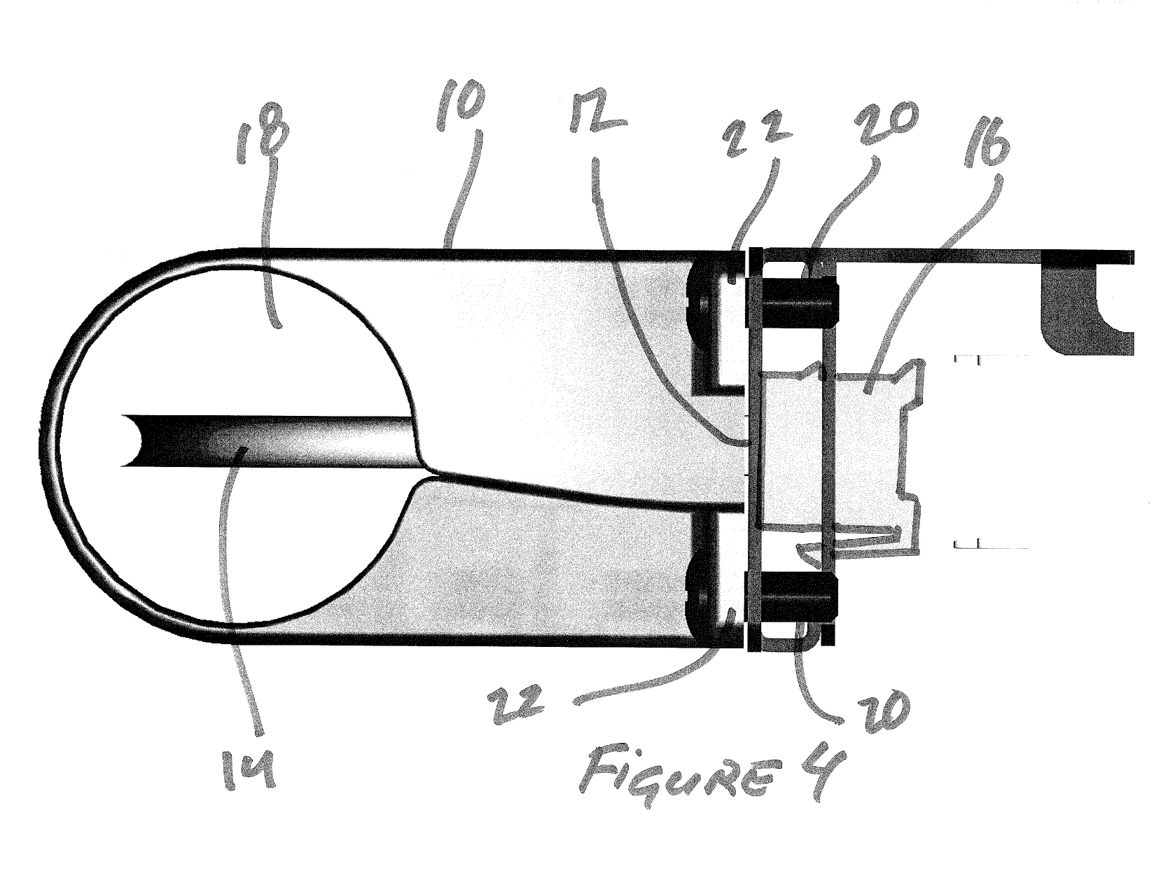

Referring now to FIG. 1, prior to mounting the protective cover 10 on the networking equipment 12 the patch cords or cables as in 14 are first inserted into their respective sockets as in 16. The patch cords or cables as in 14 may also be bundled into groups at this time. Referring now to FIG. 3 and FIG. 4 in addition to FIG. 1, in the present illustrative embodiment the protective cover 10 is manufactured from a pliable material such as plastic. As a result, the protective cover 10 can be opened (as shown in FIG. 3) and placed over the installed patch cords or cables as in 14 for subsequent fastening using the bolts 20/tabs 22 (and as shown in FIG. 4). Alternatively, the protective cover 10 as illustrated could be partially installed prior to inserting the patch cords or cables as in 14 into their respective sockets as in 16, for example by first securing the lower pair of tabs 22 of the patch cover 10 to the networking equipment 12 by the lower pairs of bolts as in 20. Given the pliable nature of the material used to fabricate the protective cover 10, the upper pair of tabs as in 22 can be subsequently positioned adjacent the upper pair of bolts as in 20 for subsequent fastening. This same approach could also be used for subsequently adding, removing or repositioning a patch cord or cable as in 14.

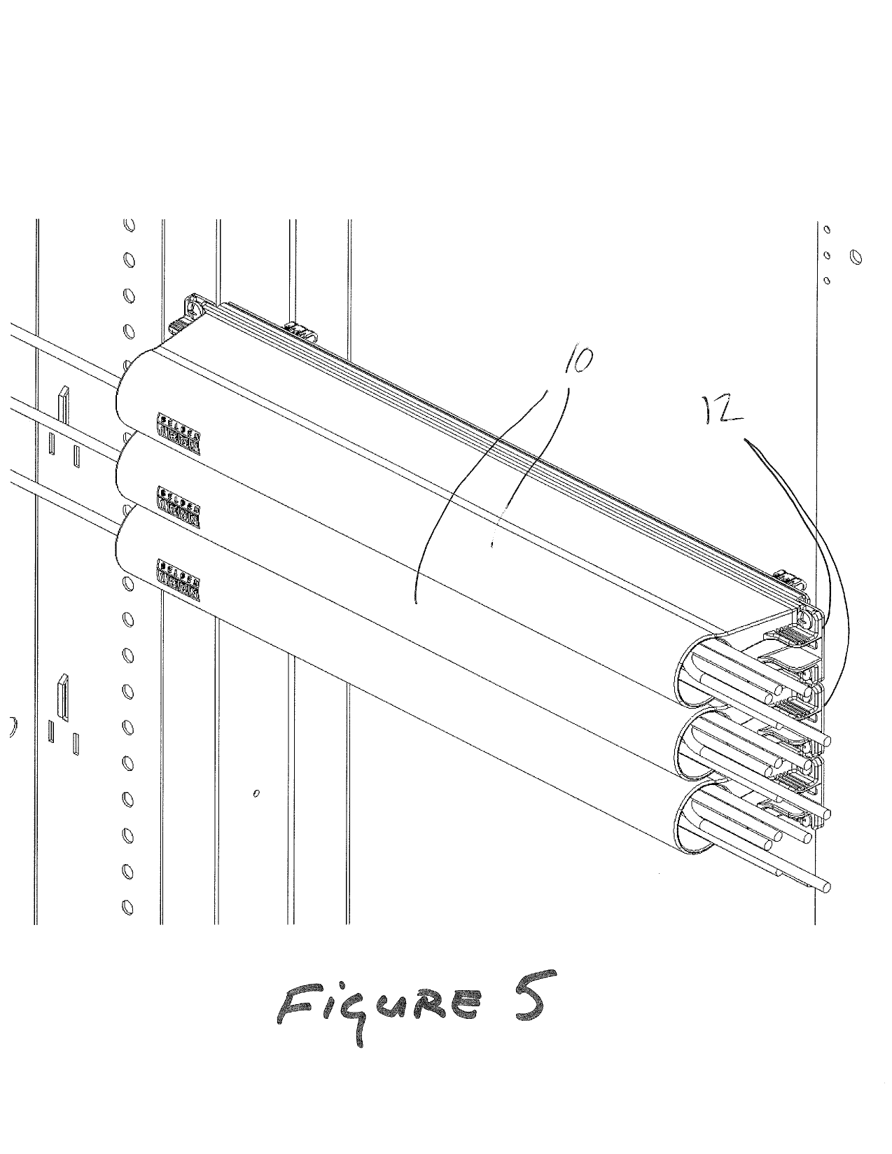

Referring now to FIG. 5, a plurality of protective covers as in 10 are shown mounted to a plurality of different pieces of networking equipment as in 12.

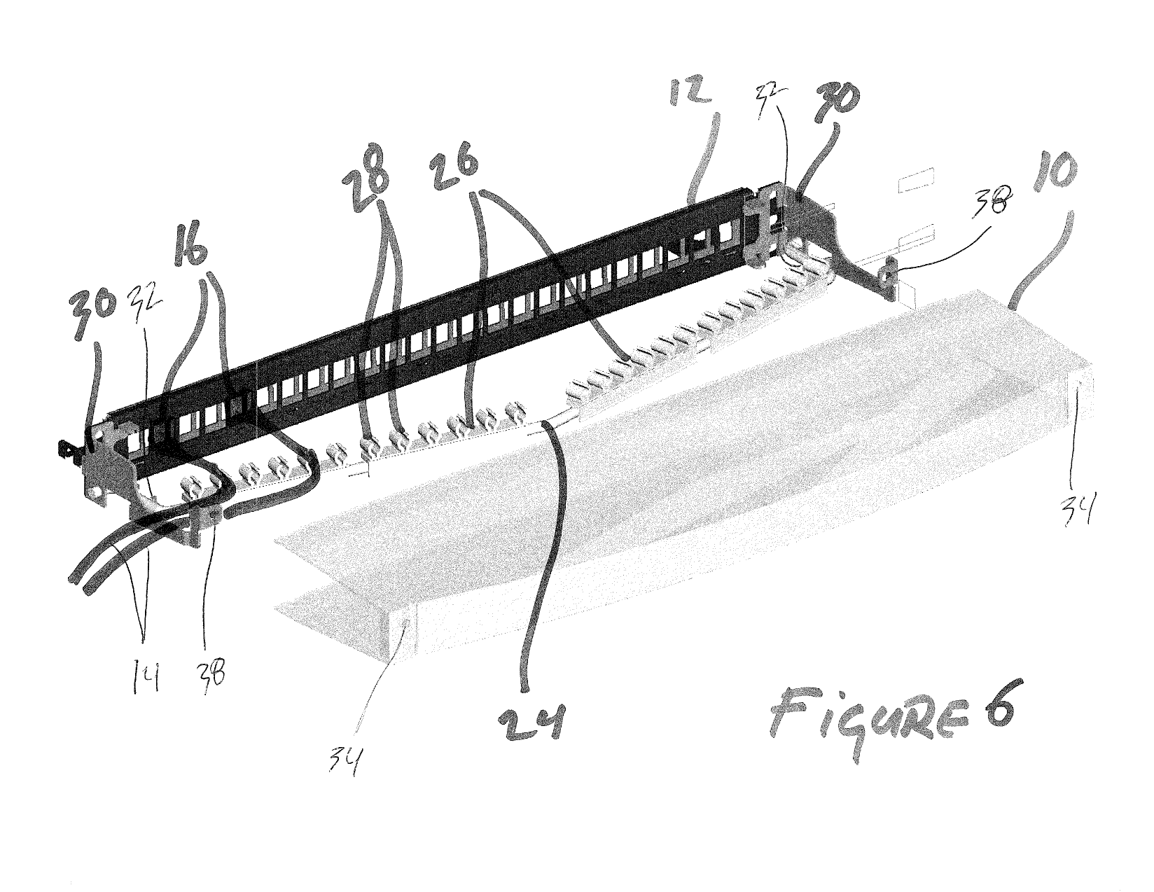

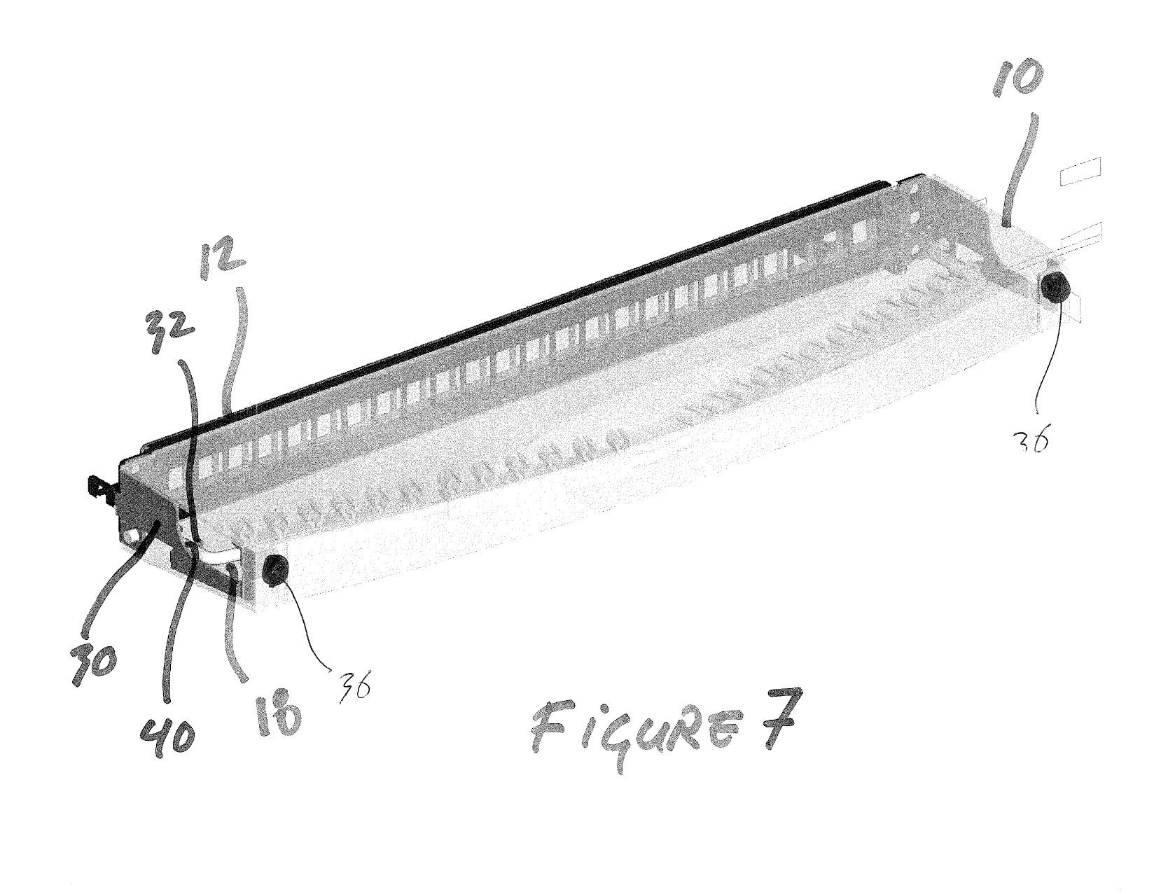

Referring now to FIGS. 6 and 7, in an alternative illustrative embodiment of the present invention the protective cover 10 is adapted to fit over a cable management bar 24 which is positioned in front of (or behind) the front face of the networking equipment 12. As known in the art, such cable management bars 24 are used to provide support for patch cords or cables as in 14 which are interconnected with corresponding sockets as in 16. Such cable management bars 24 reduce stresses which might otherwise be brought to bear on the patch cord 14/socket 16 interconnection. The cable management bar 24 may also include one or more cable guides as in 26 each comprising one or more cable clips as in 28 which help distribute and stabilise the patch cords or cables as in 14, thereby improving the reliability of the patch cord 14/socket 16 interconnection. The cable management bar 24 is illustratively pivotally mounted to a pair of brackets as in 30 which are in turn secured to the front of the networking equipment 12 using the same hardware which is used to mount the networking equipment 12 to the rack (again, not shown). In this manner, the cable management bar 24 can be raised upwards in order to provide access to the front face of the networking equipment 12 (provided, of course, that the protective cover 10 has been first removed). The cable management bar 24 is prevented from pivoting downwards by a tab as in 32 formed in each of the brackets as in 30.

Still referring to FIGS. 6 and 7, the brackets as in 30 provide a convenient means for securing the protective cover 10 to the networking equipment 12. In this regard, a pair of holes as in 34 are provided in the protective cover 10 through which a corresponding pair of fasteners as in 36 (such as threaded bolts) can be inserted. The bolts as in 36 mate with a pair of threaded holes as in 38 machined in the forward ends of the brackets as in 30. It will now be apparent to a person of ordinary skill in the art that the protective cover 10 can be secured or removed at will from the networking equipment 12 by respectively simply tightening or removing the threaded bolts as in 36.

Still referring to FIGS. 6 and 7, the brackets as in 30 each comprise a cut away portion 40 which, together with the edge of the protective cover 10 define a side opening 18 through which the patch cords or cables as in 14 may be pass when the protective cover 10 is installed.

As will now be apparent to a person of skill in the art, the protective cover 10 provides protection against vandalism, improves the integrity of the patch cord/cable networking equipment in the presence of shocks and other physical stresses, provides a mechanism for supporting and bundling groups of patch cords or cables from a position in front (or behind) the networking equipment 12 to a position in the side opening that is perpendicular to the front (or rear) plain of the networking equipment 12. The position transposition effect of the protective cover 10 can be applied to all patch cords or cables as in 14 or only a portion of patch cords or cables as in 14 depending on implementation. The protective cover 10 can be made of rigid or flexible material as required by the particular application. Additionally, although in a number of the above referenced figures the protective cover 10 is shown as being translucent (primarily in order to view what would otherwise be hidden components and features), the protective cover 10 is typically manufactured from an opaque material. However, use of a translucent or transparent material provides some advantages, for example the patch cord 14/socket 16 interconnection would then remain visible even with the protective cover 10 installed. Additionally, the transparent protective cover 10 could also be combined with a patch cord 14 identification system.

In an additional alternative illustrative embodiment the protective cover 10 could also be made of materials improving electrical performance and electro-magnetic shielding. As is apparent from the figures, the protective cover 10 is illustratively mounted to the networking equipment 12 such that it can be partially or completely be removed with the use of common or special tools (not shown) thereby providing access to the patch cord or cable as in 14 without disturbing the existing equipment installation. Additionally, the protective cover 10 could also form an integrated component of either the networking equipment 12 or the rack (not shown).

Although the present invention has been described hereinabove by way of an illustrative embodiment thereof, this embodiment can be modified at will without departing from the spirit and nature of the subject invention.

What is claimed is:

1. A protective cover for securing networking equipment installed on a rack, the networking equipment comprising a front face including at least one cable plug receiving socket and at least one cable terminated by one of the sockets, the cover comprising:
an elongate covering portion dimensioned to conceal the front face and defining a cable receiving region, said covering portion comprising at least one side opening at an end thereof; and
a means for mounting said covering portion to the front face;
wherein the at least one cable exits said cable receiving region via said side opening.
